(19) United States
(12) Patent Application Publication
(10) Pub. No.: US 2020/0185705 A1
(43) Pub. Date: Jun. 11, 2020

(54) RECHARGEABLE BATTERY, ELECTRODE STRUCTURE AND METHOD OF MANUFACTURING THE SAME

(71) Applicant: NATIONAL CHENG KUNG UNIVERSITY, TAINAN CITY (TW)

(72) Inventors: Jih-Jen WU, Tainan City (TW); Huei Lian CHEN, Pingtung City (TW)

(73) Assignee: NATIONAL CHENG KUNG UNIVERSITY, TAINAN CITY (TW)

(21) Appl. No.: 16/213,662

(22) Filed: Dec. 7, 2018

(51) Int. Cl. H01M 4/139; H01M 4/48; H01M 4/66; H01M 4/74; H01M 4/04

(52) U.S. Cl. CPC H01M 4/139; H01M 4/483; H01M 4/0404; H01M 4/661; H01M 4/745; H01M 4/663

(57) ABSTRACT

An electrode structure includes a mesh substrate and a nanomaterial. The nanomaterial contains oxide of group IVA element and grows on the mesh substrate. A method of manufacturing the electrode structure and a rechargeable battery including the electrode structure are also provided.

### BACKGROUND

### 1. Technical Field

This present disclosure relates to an electrode structure, a method of manufacturing the electrode structure, and a battery including the electrode structure.

### 2. Related Art

Recently, rechargeable batteries have been applied in various technical fields. For example, lithium batteries have been widely used in electronic devices, vehicles, national defense, military and aerospace fields. Conventionally, a negative electrode of a lithium battery is fabricated by casting a slurry composed of active materials, binder, and conductive agent on a metal foil followed by heat-treatment. The active material dispersed in the slurry contributes to the charge capacity of the electrode. In order to ensure the adhesion between the active material and the substrate, the slurry generally contains a binder, and the binder causes an increase charge transport distances of electrons and lithium ions, such that a first cycle coulombic efficiency is low, and the stability of the charge and discharge cycle is also deteriorated. Even though an additional conductive agent is added into the slurry, it is still difficult to solve the above problem.

Moreover, silicon or metal oxide is used as a high capacity material for electrode. However, the volume of silicon or metal oxide may overly expand during the charging and discharging processes, and the volume expansion causes cracks in the electrode structure. The cracks in the electrode structure make the capacity reduced after several cycles of charging and discharging. In addition, a manufacturing process of silicon nanomaterials is complicated and harmful to the environment, and thus it is difficult to reduce the manufacturing cost of the electrode of rechargeable battery.

### SUMMARY

According to one aspect of the present disclosure, an electrode structure includes a mesh substrate and a nanomaterial. The nanomaterial contains oxide of group IVA element and grows on the mesh substrate.

According to another aspect of the present disclosure, a rechargeable battery includes the aforementioned electrode structure.

According to still another aspect of the present disclosure, a method of manufacturing electrode structure includes: growing a nanomaterial containing metal oxide on a mesh substrate; growing a nanomaterial containing oxide of group IVA element on the mesh substrate, wherein the nanomaterial containing oxide of group IVA element covers the nanomaterial containing metal oxide; and removing the nanomaterial containing metal oxide.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a perspective view of an electrode structure according to one embodiment of the present disclosure;

FIG. 2 is a partially enlarged view of the electrode structure in FIG. 1; and

FIG. 3 through FIG. 6 are schematic views of manufacturing the electrode structure in FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

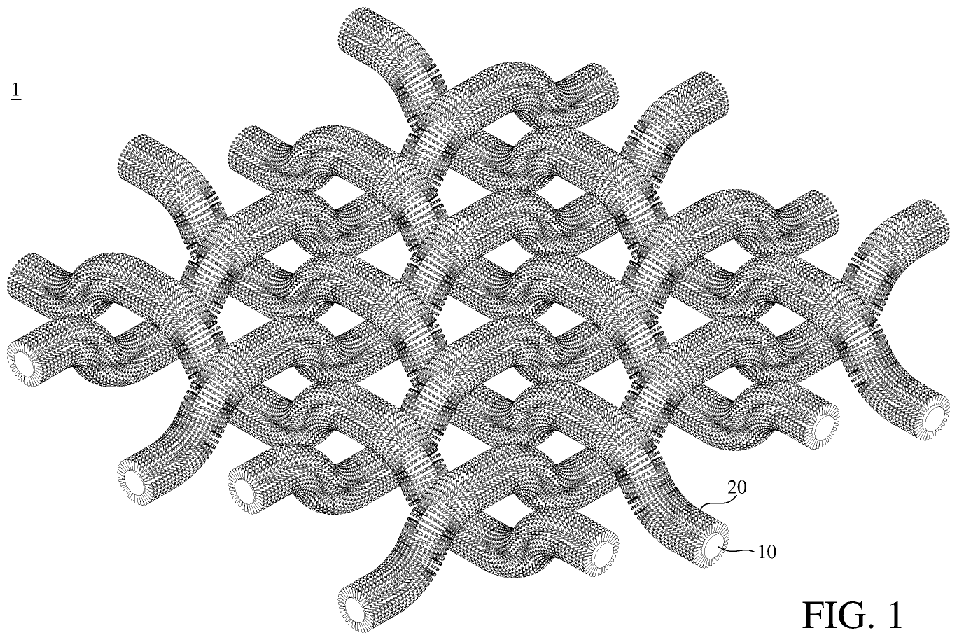

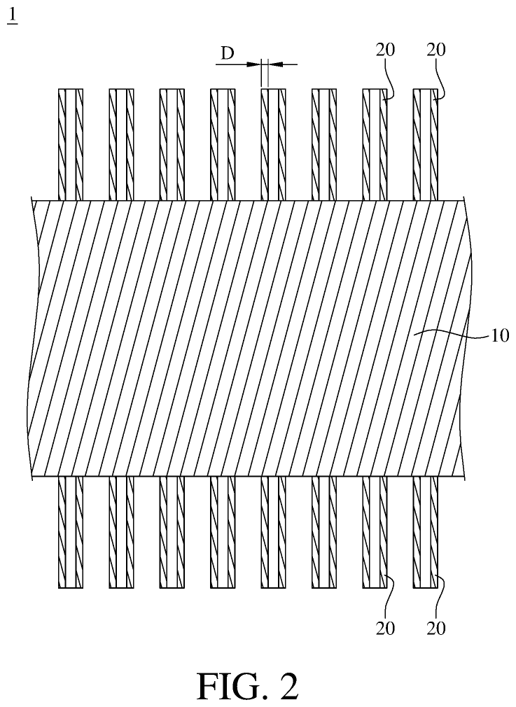

Please refer to FIG. 1 and FIG. 2. FIG. 1 is a perspective view of an electrode structure according to one embodiment of the present disclosure. FIG. 2 is a partially enlarged view of the electrode structure in FIG. 1. In this embodiment, an electrode structure 1, for example but not limited to, is a negative electrode of lithium ion battery. The electrode structure 1 includes a mesh substrate 10 and multiple nanomaterials 20. It is worth noting that the protective scope of the present disclosure is not limited to the numbers of nanomaterial 20 in the electrode structure 1.

The mesh substrate 10 is an electrically conductive substrate with porous structure or weaving structure. In this embodiment, the mesh substrate 10 is a flexible carbon fiber sheet or a flexible conductive nonwoven fabric including two dimensional structure. The carbon fiber sheet is produced by weaving multiple carbon fibers. In some embodiments, the mesh substrate 10 is a flexible nickel foam including three dimensional porous structure, and the holes in the porous structure has similar size or different sizes. It is worth noting that the protective scope of the present disclosure is not limited to the specific example of the mesh substrate 10.

The nanomaterial 20 contains oxide of group IVA element in the periodic table of the chemical elements. The nanomaterial 20 grows on the mesh substrate 10. In this embodiment, the nanomaterial 20 contains silicon oxide (SiOx); more specifically, the nanomaterial 20 is a silicon oxide nanotube, such as silicon dioxide (SiO₂) nanotube. In some embodiments, the nanomaterial 20 contains tin oxide. In some other embodiments, the nanomaterial 20 is a nanoband or nanowire.

In comparison with a metal substrate having flat surfaces, the mesh substrate 10 with two dimensional structure or three dimensional structure has higher specific surface area, such that it is favorable for growing a high density layer of nanomaterial 20 on the mesh substrate 10, thereby improving charge/discharge capacity of a battery including the electrode structure 1.

Furthermore, as shown in FIG. 2, in this embodiment, a wall thickness D of the nanomaterial 20 containing oxide of group IVA element (silicon oxide nanotube) is from 5.0 nanometers (nm) to 20.0 nm. In one embodiments, the wall thickness of the nanomaterial containing oxide of group IVA element is from 10.0 nm to 12.0 nm. Therefore, it is favorable for obtaining a balance between enhancement of capacity and decrease of charge transport distances of the electrons and the lithium ions. In some embodiments, as the wall thickness of the silicon oxide nanotube is overly small, the capacity of the battery is insufficient; as the wall thickness of the silicon oxide nanotube is overly large, the charge transport distances are overly long so as to be unfavorable for charging and discharging cycles.

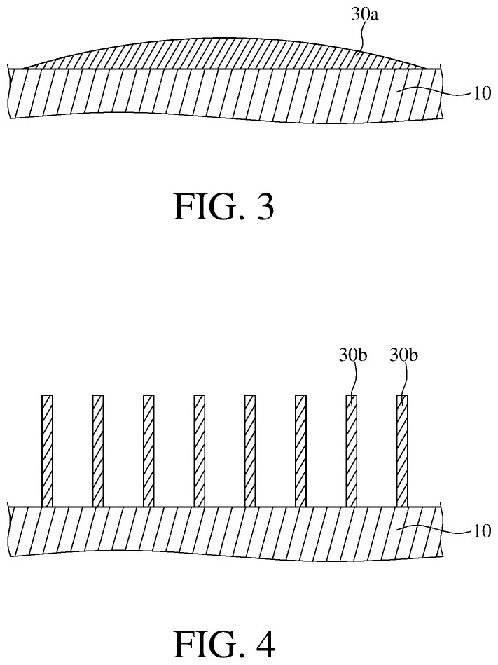

A method of manufacturing the electrode structure 1 is described hereafter. FIG. 3 through FIG. 6 are schematic views of manufacturing the electrode structure in FIG. 1. The mesh substrate 10 is a carbon fiber sheet for an example in FIG. 3. The mesh substrate 10 is immersed into a solution including metal acetic salt and ethanol. The mesh substrate 10 and the solution are heated to form at least one metal oxide seed 30a which are grow on the mesh substrate 10. The metal acetic salt, for example but not limited to, is zinc acetate (Zn(OAc)₂) or nickel acetate (Ni(OAc)₂). The metal oxide seed 30, for example but not limited to, is zinc oxide (ZnO) or nickel oxide (NiO).

As shown in FIG. 4, multiple nanomaterials 30b containing metal oxide grow on the mesh substrate 10. In detail, the mesh substrate 10 where the metal oxide seed grows, is immersed into a solution including zinc acetate. The mesh substrate 10 and the solution are heated to make the metal oxide seed 30a react with the solution, thereby growing nanomaterials 30b containing metal oxide on the mesh substrate 10. In a condition that the metal oxide seed 30a is ZnO, the nanomaterial 30b is ZnO nanomaterial. It is worth noting that the protective scope of the present disclosure is not limited to the aforementioned method of forming nanomaterial 30b.

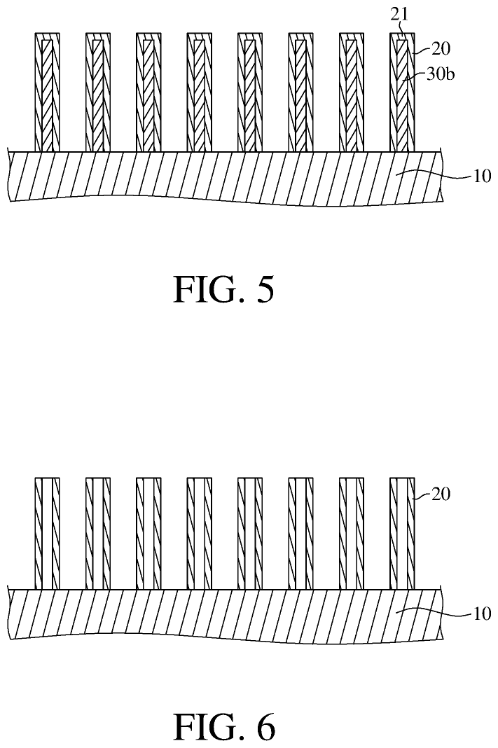

As shown in FIG. 5 and FIG. 6, multiple nanomaterials 20 containing oxide of group IVA element grow on the mesh substrate 10, and the nanomaterial 20 covers the nanomaterial 30b. For example, the nanomaterials 20, which cover the nanomaterial 30b, are silicon oxide nanotubes growing on the mesh substrate 10 by sol-gel process or atomic layer deposition. The mesh substrate 10, where the nanomaterials 20 containing oxide of group IVA element and the nanomaterials 30b containing metal oxide grow, is immersed into an etching solution to remove the nanomaterials 30b. In some embodiments, an additional dry etching step or wet etching step is performed to remove a cap 21 located on one end of the nanomaterial 20 away from the mesh substrate 10. Once the cap 21 is removed, the battery electrolyte can easily flow into a cavity formed by the mesh substrate 10 and the nanomaterial 20.

According to the above description of the present disclosure, the following specific embodiments are provided for further explanation.

### EMBODIMENT

An embodiment of the present disclosure provides an electrode structure including a carbon fiber sheet and multiple silicon oxide nanotubes growing on the carbon fiber sheet. A method of manufacturing the electrode structure is described in the following paragraphs.

### Step 1

The carbon fiber sheet is immersed into a solution including zinc acetate, sodium hydroxide and ethanol. The carbon fiber sheet and the solution are heated at 150° C. for 40 minutes to grow zinc oxide seeds on the carbon fiber sheet.

### Step 2

The carbon fiber sheet, where the zinc oxide seeds grow, is immersed into a solution including Milli-Q water, zinc acetate and hexamethylenetetramine (HMTA). The carbon fiber sheet and the solution are heated at 95° C. for 3 hours to grow zinc oxide nanowires.

### Step 3

The carbon fiber sheet, where the zinc oxide nanowires grow, is immersed into a solution including tetraethoxysilane (TEOS) and ammonia. Multiple silicon oxide nanotubes grow on the carbon fiber sheet by sol-gel process and cover the zinc oxide nanowires. The sol-gel process is a conventional method for producing solid materials from small molecules.

### Step 4

The carbon fiber sheet, where the zinc oxide nanowires and the silicon oxide nanotubes grow, is immersed into hydrochloric acid solution, such that the zinc oxide nanowires are removed by wet etching. The silicon oxide nanotubes are remained on the carbon fiber sheet, and an average wall thickness of the silicon oxide nanotube is about 11.0 nm.

### 1st Comparative Embodiment

The first (1st) comparative embodiment provides an electrode structure including a carbon fiber sheet and multiple zinc oxide nanowires growing on the carbon fiber sheet.

### 2nd Comparative Embodiment

The second (2nd) comparative embodiment provides an electrode structure including a carbon fiber sheet and multiple silicon oxide nanowires growing on the carbon fiber sheet.

### 3rd Comparative Embodiment

The third (3rd) comparative embodiment provides an electrode structure including a carbon fiber sheet and a slurry composition spread on the carbon fiber sheet. The slurry composition includes multiple silicon oxide nanotubes, a binder and a conductive agent. The binder, for example, is styrene-butadiene rubber (SBR), and the conductive agent is graphite powder.

For a rechargeable battery including the electrode structure in each of the embodiment and the 1st comparative embodiment, after several cycles of charging and discharging under the same current density, the electrochemical properties are shown in TABLE 1 below.

TABLE 1

Capacity (mAh/g)

| | | 1st comparative |
|---|---|---|
| Charge cycle | Embodiment | embodiment |

| | | | |
|---|---|---|---|
| 20 | cycles | 1655 | 984 |
| 50 | cycles | 1633 | 692 |
| 100 | cycles | 1616 | 685 |

According to TABLE 1, the electrode structure in the embodiment of the present disclosure has the advantage of high capacity. In addition, after 100 charge cycles, the capacity in the embodiment has less reduction than the capacity in the 1st comparative embodiment, and thus the electrode structure in the embodiment of the present disclosure shows high cycle life.

For a rechargeable battery including the electrode structure in each of the embodiment and the 2nd comparative embodiment, after several cycles of charging and discharging under the same current density, the electrochemical properties are shown in TABLE 2 below.

TABLE 2

Volume expansion ratio of
the electrode structure

| | | 2nd comparative |
|---|---|---|
| Charge cycle | Embodiment | embodiment |
| 10 cycles | Approximately 130% | 145% |
| 50 cycles | Approximately 200% | Larger than 300% |

According to TABLE 2, the electrode structure in the embodiment of the present disclosure has less volume expansion ratio than the electrode structure in the 2nd comparative embodiment. Thus, a configuration of the electrode structure in the embodiment of the present disclosure is favorable for preventing cracks, thereby extending the lifespan of rechargeable battery.

For a rechargeable battery including the electrode structure in each of the embodiment and the 3rd comparative embodiment, after a first cycle of charging and discharging under the same current density, the electrochemical properties are shown in TABLE 3 below.

TABLE 3
First cycle coulombic efficiency

| Embodiment | 3rd comparative embodiment |
|---|---|
| 90.7% | 86.4% |

According to TABLE 3, the electrode structure in the embodiment of the present disclosure has higher coulombic efficiency than the electrode structure in the 3rd comparative embodiment.

According to the present disclosure, the electrode structure includes a mesh substrate where nanomaterials containing oxide of group IVA element grow, thereby meeting the requirements of high capacity, low volume expansion ratio and high first cycle coulombic efficiency. Furthermore, since the nanomaterial containing oxide of group IVA element grows on the mesh substrate to form strong chemical bonding between the nanomaterial and the mesh substrate, it is favorable for providing reliable adhesion and electrical conductivity, such that the electrode structure is provided without any binder and also without any conductive agent.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. An electrode structure, comprising:
a mesh substrate; and
a nanomaterial containing oxide of group IVA element growing on the mesh substrate.

2. The electrode structure according to claim 1, wherein the nanomaterial contains silicon oxide.

3. The electrode structure according to claim 1, wherein the nanomaterial containing oxide of group IVA element is a silicon oxide nanotube.

4. The electrode structure according to claim 3, wherein a thickness of the silicon oxide nanotube is from 5.0 nanometers (nm) to 20.0 nm.

5. The electrode structure according to claim 1, wherein the mesh substrate is flexible.

6. The electrode structure according to claim 1, wherein the mesh substrate is a carbon fiber sheet, a conductive nonwoven fabric or a nickel foam.

7. The electrode structure according to claim 1, wherein the electrode structure is without binder and conductive agent.

8. A rechargeable battery, comprising the electrode structure according to claim 1.

9. A method of manufacturing electrode structure, comprising:
growing a nanomaterial containing metal oxide on a mesh substrate;
growing a nanomaterial containing oxide of group IVA element on the mesh substrate, wherein the nanomaterial containing oxide of group IVA element covers the nanomaterial containing metal oxide; and
removing the nanomaterial containing metal oxide.

10. The method according to claim 9, wherein the mesh substrate is a carbon fiber sheet, a conductive nonwoven fabric or a nickel foam, the nanomaterial containing metal oxide is a zinc oxide nanowire, and the nanomaterial containing oxide of group IVA element is a silicon oxide nanotube.
